(19) United States
(12) Patent Application Publication
(10) Pub. No.: US 2009/0240899 A1
(43) Pub. Date: Sep. 24, 2009

(54) Storage device and method of controlling same

(75) Inventors: Etsutaro Akagawa, Kawasaki (JP); Takahiro Nakano, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi Ltd.

(21) Appl. No.: 12/149,736

(22) Filed: May 7, 2008

(30) Foreign Application Priority Data
Mar. 21, 2008 (JP) 2008-073984

(51) Int. Cl. G06F 12/00

(52) U.S. Cl. 711/154; 711/E12.001

(57) ABSTRACT

A storage device having a volume for storing data sent from a host computer and transferring the data stored in the volume to a sub storage device via a network, comprises: a retrieval unit for retrieving a snapshot retaining change data generated in the volume during a time period between a given time and another given time, and a maximum transfer size of the network between the storage device and the sub storage device; and a control unit for controlling so as to store data exceeding a maximum transfer size in the area of another snapshot, when the size of a created snapshot exceeds the maximum transfer size.

### CROSS-REFERENCES TO RELATED APPLICATIONS

This application relates to and claims priority from Japanese Patent Application No. 2008-073984, filed on Mar. 21, 2008, the entire disclosure of which is incorporated herein by reference.

### BACKGROUND

The invention relates generally to a storage device and a method of controlling the same, and in particular, relates to a computer system having a function to copy data between more than one computer.

Recently, storage consolidation, in which data stored in each server is consolidated in one storage device, is widely used. One of the characteristics of a storage device is a snapshot feature. The snapshot feature is a feature for storing snapshots in a storage device, which are images that existed in a storage system at certain points in time, and users can read and write data as usual after the snapshots are stored. Furthermore, even when a user has updated data after creating snapshots, the user can trace back and access to the snapshots at certain points in time. Therefore, the snapshot feature is particularly helpful as a way to restore data when, for example, the user accidentally causes data corruption.

A technique to transfer a snapshot created in main storage device to a backup storage device is disclosed in JP2007-286860 A.

Also, in order to continue business even when a main storage device is disabled by a disaster or similar, a type of method in which a backup storage device is established at a remote location and data is transferred and restored by connecting those storage devices via lines is widely used.

A method of comparing a previously transferred snapshot with a snapshot to be transferred and transferring only the difference between both snapshots is disclosed in U.S. Pat. No. 6,901,414. Generally, the transfer amount can be reduced by transferring only the difference from the previously transferred snapshot, rather than by transferring all data.

Line loads become heavy during the period in which data is transferred from a storage device to another storage device in preparation for a possible disaster or similar, and as a result, it may have an impact on regular business activity using the lines. In order to prevent such an impact, an administrator usually limits the time of replication to, for example, late at night, in advance; and executes the above-described replication.

However, since the bandwidth of a line between storage devices is limited, the amount of data that can be transferred within the above-restricted time frame is limited. Meanwhile, the amount of data generated in business activities varies depending on the kind of work, so in some cases, the amount of generated data may exceed the available transfer amount. In those cases, it is impossible to complete the replication within a pre-restricted time frame, and accordingly a problem having an impact on regular business activities will arise.

Even if only the difference is transferred as described in U.S. Pat. No. 6,901,414, the entire file has to be transferred eventually, because newly generated files haven't been transferred. If the size of a file exceeds the available transfer amount for data, the method disclosed in JP2007-286860 A cannot solve the above-described problem; in other words, there is a problem in that data cannot be protected if the amount of data to be transferred exceeds the available transfer amount when data is copied between storage devices.

### SUMMARY

The current invention has been devised in consideration of the above-described points, and An object of the present invention is to provide a highly reliable storage device and a method of controlling the same.

In order to solve the above-described problems, according to an aspect of the invention, a storage device having a volume for storing data sent from a host computer and transferring the data stored in the volume to a sub storage device via a network, comprises: a retrieval unit for retrieving a snapshot retaining change data occurred in the volume during a time period between a given time and another given time, and a maximum transfer size of the network between the sub storage device; and a control unit for controlling so as to store data exceeding a maximum transfer size in the area of another snapshot, when the size of a created snapshot exceeds the maximum transfer size.

According to another aspect of the invention, a method of controlling a storage device including a volume for storing data sent from a host computer and transferring the data stored in the volume to a sub storage device via a network, comprises: a first step wherein a retrieval unit retrieves a snapshot retaining change data generated in the volume during a time period between a given time and another given time, and a maximum transfer size of the network between the storage device and the sub storage device; and a second step wherein a control unit controls the storage device so as to store data exceeding a maximum transfer size in the area of another snapshot, when the size of a created snapshot exceeds the maximum transfer size.

Accordingly, the present invention can backup data, even if the amount of data to be transferred exceeds the available transfer amount when data is copied between storage devices.

According to the present invention, a highly reliable storage device and a method of controlling the same can be achieved.

Other aspects and advantages of the invention will be apparent from the following description and the appended claims.

### BRIEF DESCRIPTION OF THE DRAWINGS

FIG. 1 is a schematic diagram showing a computer system according to respective embodiments.

FIG. 2 is a block diagram showing a management computer according to respective embodiments.

FIG. 3 is a block diagram showing a copy-on-write (COW) table.

FIG. 4 is a block diagram showing a remote copy management table.

FIG. 5 is a block diagram showing a management screen provided to an administrator.

FIG. 6 is a flowchart illustrating processing steps in the first embodiment.

FIG. 7 is a flowchart illustrating the first half of processing steps in the second embodiment.

FIG. 8 is a flowchart illustrating the second half of processing steps in the second embodiment.

FIG. 9 is a block diagram showing a difference data volume according to the third embodiment.

FIG. 10 is a block diagram showing an availability table according to the third embodiment.

FIG. 11 is a flowchart illustrating processing steps in the third embodiment.

FIG. 12 is a block diagram showing memory according to the fourth embodiment.

FIG. 13 is a block diagram showing a snapshot schedule table according to the fourth embodiment.

FIG. 14 a flowchart illustrating processing steps in the fourth embodiment.

### DETAILED DESCRIPTION OF PREFERRED EMBODIMENTS

Embodiments of the present invention will be described below with reference to the attached drawings. It should be understood that the present invention is not limited to these embodiments.

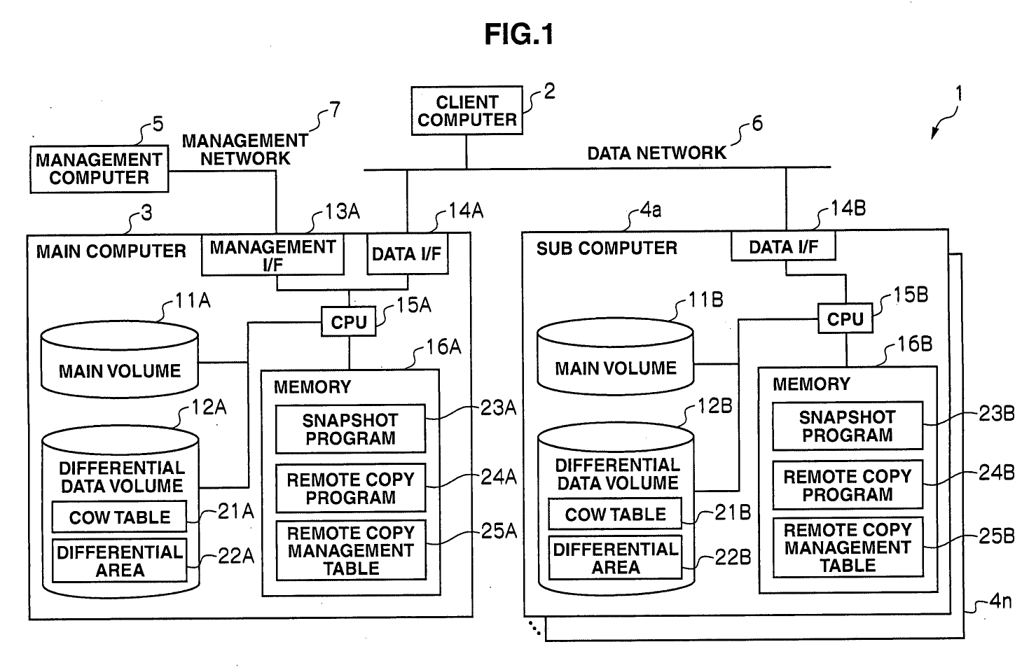

FIG. 1 shows the overview of a computer system 1 in the invention. The computer system 1 is configured by including a client computer (a host computer) 2, a main computer (a main storage device) 3, a sub-computer (a sub storage device) 4, and a management computer 5.

The client computer 2 is a computer device provided with a CPU (Central Processing Unit), and an information-processing resource (not shown), such as memory; and it is, for example, a personal computer, a work station, or a mainframe, etc. Also, the client computer 2 is configured by including a host bus adaptor (FC HBA) (not shown) for connecting to a data network 6. Furthermore, the client computer 2 is configured by including information input devices (not shown), such as a keyboard, a switch, a pointing device, and a microphone, and information output devices (not shown), such as a monitor display, and a speaker.

The main computer 3 is configured by including a main volume 11A, a difference data volume 12A, a management interface 13A (hereinafter referred to as “management I/F 13A”), a data interface 14A (hereinafter referred to as the “data I/F 14A”), CPU 15A, and memory 16A.

A copy-on-write table 21A (hereinafter referred to as “COW table 21A”) and a differential area 22A are arranged in the difference data volume 12A. The main volume 11A is suitable for being used as a file system or database. A snapshot program 23A, a remote copy program 24A, and a remote copy management table 25A are arranged in the memory 16A, and the main computer 3 executes the snapshot program 17A and the remote copy program 18A by using the CPU 15A.

The main computer 3 and the sub-computers 4a-4n (hereinafter referred to as the “sub-computer 4”) are interconnected via the data network 6. The sub-computer 4 is configured the same way as the main computer 3, except that the sub-computer 4 does not include the management I/F 13A. In FIG. 1, each component in the sub-computer 4 the same as those in the main computer 3 will be numbered with the same reference numerals as those numbered in the main computer 3, and the reference numerals will be followed by the letter “B” in place of the letter “A.”

The client computer 2 is also connected to the data network 6. The main computer 3 can receive requests from the client computer 2 and can send processing results. For example, Ethernet (registered trademark) or Fibre Channel is suitable for a protocol used in the data network 6.

The main computer 3 and the management computer 5 are interconnected via a management network 7. The main computer 3 can receive instructions from the management computer 5 and can send processing results. For example, Ethernet (registered trademark) is suitable for a protocol used in the management network 7. Network configuration can be simplified by using both the data network 6 and the management network 7.

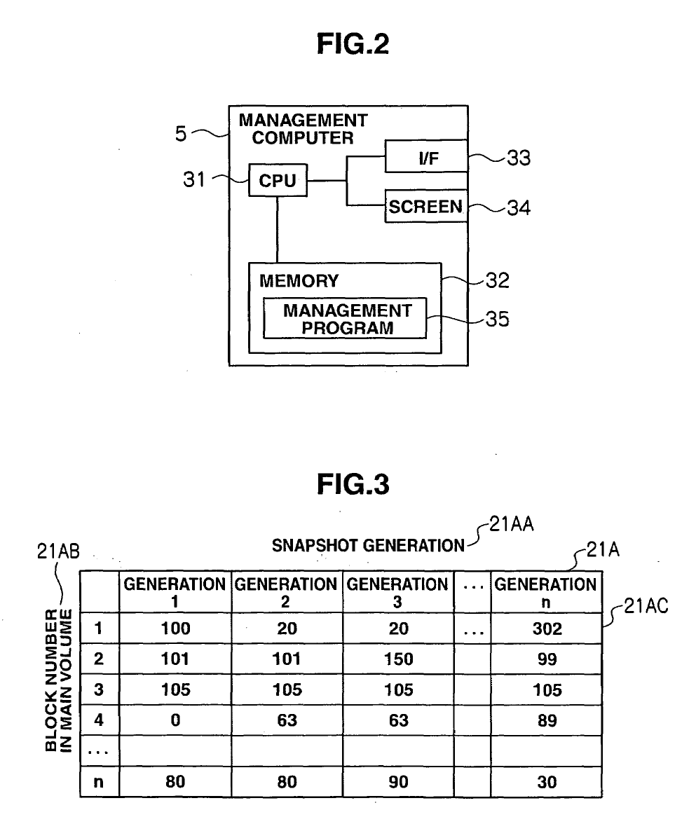

FIG. 2 shows the configuration of the management computer 5. The management computer 5 is configured by including a CPU 31, memory 32, an interface 33 (hereinafter referred to as “I/F 33”), and a screen 34. A management program 35 is arranged in the memory 32.

The management computer 5 executes the management program 35 in the memory 32 by using the CPU 31, and manages via the I/F 33 the main computer 3 connected via the data network 6. Also, the management computer 5 can provide the screen 34 as an interface for an administrator to access the management program 35.

FIG. 3 is an example of the COW table 21. The COW table 21A includes, at least, a row 21AA representing the generation of a snapshot and a column 21AB representing a block number in the main volume 11A. Data is retained in a block in the differential area 22A, and the difference block number 21AC for that block is retained at the junction of the row and column, so that data varying from generation to generation can be written in each block in the main volume 11A.

When retrieving the main volume 11A of a particular generation, the main computer 3 can retrieve the difference block number 21AC in the differential area 22A corresponding to each block number in the main volume 11A by referring to the COW table 21A, thereby a purpose for which it was originally intended can be achieved by retrieving data written in the difference block number 21AC.

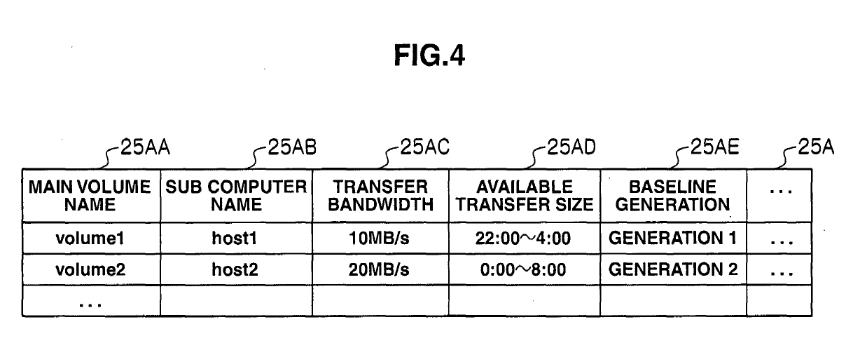

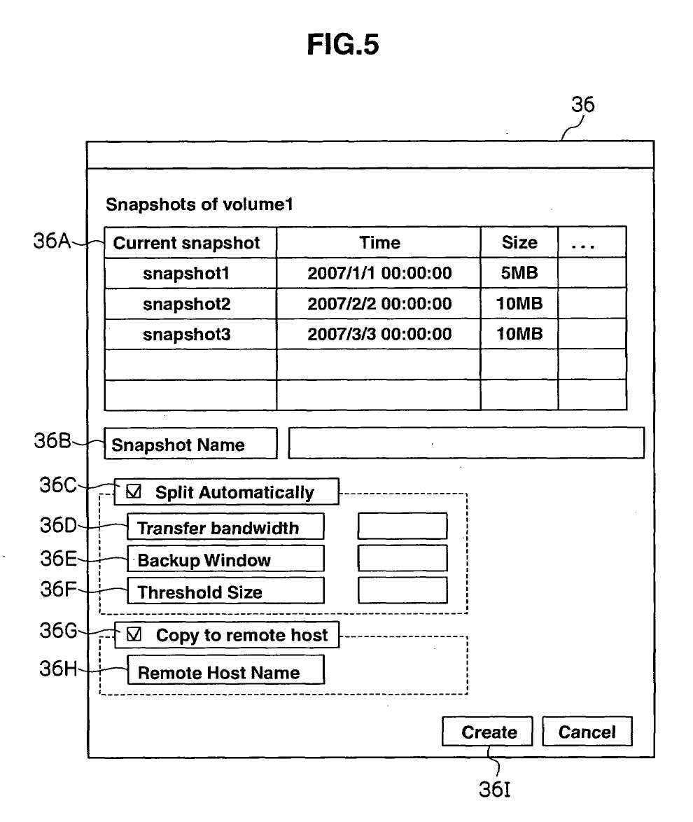

FIG. 4 is an example of a remote copy management table 25A. The remote copy management table 25A includes, at least, a main volume name 25AA for which a snapshot creation is targeted, a sub-computer name 25AB to which a snapshot is transferred, a transfer bandwidth 25AC with the sub-computer, a available transfer time 25 AD showing the time frame in which data can be transferred to the sub-computer 4, and a baseline generation 25AE representing a reference generation for transferring the snapshot. The sub-computer name 25AB may be an identifier which can identify the sub-computer 4, and for example, a host name or IP address of the sub-computer 4 is suitable.

FIG. 5 is an example of a screen layout 36 (GUI: Graphical User Interface) displayed on the screen 34 by the CPU 31 executing the management program 35 when an administrator intends to create a new snapshot in the main volume 11A by executing the management program 35. The screen layout 36 includes, at least, a table 36A for listing a currently created snapshot and an attribute thereof, an area 36B for entering the name of a newly created snapshot, and a create button 36C for directing the snapshot program 23A to create a snapshot; and further includes a select button 36C for selecting whether or not to split a snapshot automatically, an area 36D for entering a transfer bandwidth when transferring data to the sub-computer 4, an area 36E for entering a available transfer time frame, an area 36F for entering a threshold value for a transferable size for data, a transfer button 36G for selecting whether or not to transfer data to a snapshot automatically after creating the snapshot, and an area 36H for entering the name of a transfer destination sub-computer when transferring data. Furthermore, the screen layout 36 may have a feature capable of multiplying the values in the area 36D and area 36E and automatically displaying the multiplication result in an area 36F.

### (1) First Embodiment

The first embodiment illustrates a method of creating a snapshot so as to prevent the difference amount from the snapshot of the previous-generation from exceeding an available transfer size determined from the transfer bandwidth and available transfer time frame.

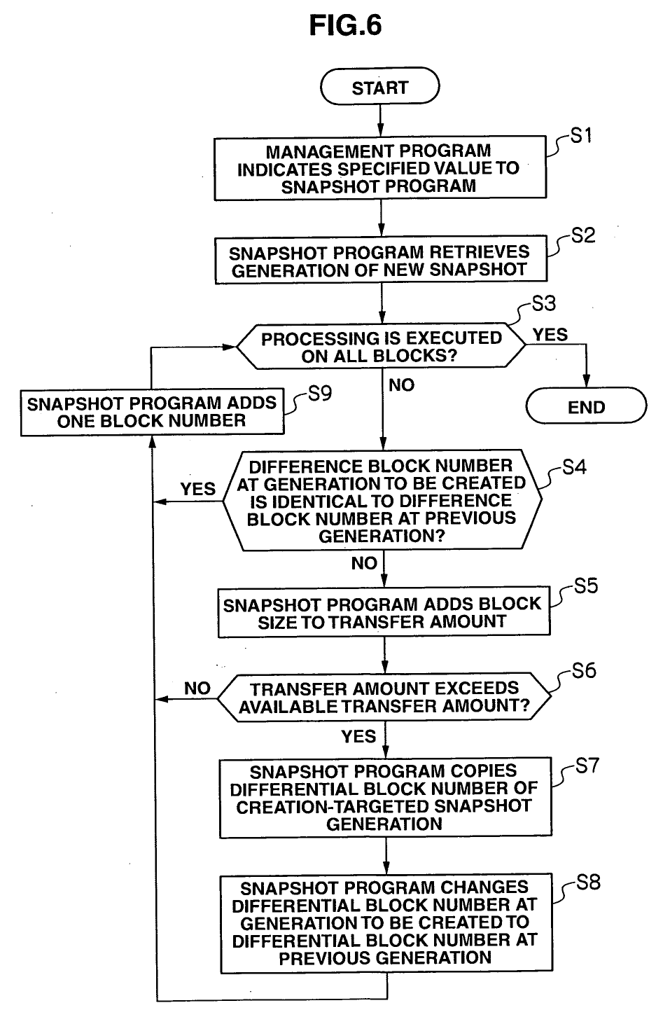

FIG. 6 is a flowchart illustrating processing steps that will be described in the first embodiment. The first embodiment will be described below with reference to this flowchart. Incidentally, in order to clearly describe the content of the processing, the entire processing in the CPU 15A in the main computer 3, the CPU 15B in the sub-computer 4, or the CPU 31 in the management computer 5 in the first embodiment described below will be respectively described as a program, and obviously, the correspondings CPU 15A, 15B, and 31 will actually execute that processing based on that program.

First, when an administrator specifies the main volume name 25AA of the main volume 11A, for which the administrator intends to create a snapshot, the transfer bandwidth 25AC, and the available transfer time frame 25AD; and presses the create button 361, the management program 35 in the management computer starts processing steps in the flowchart according to the first embodiment and directs the main computer 3 to create a new snapshot by specifying the main volume name 25AA of the main volume 11A, the transfer bandwidth 25AC, and the available transfer time frame 25AD (S1).

In that case, if the relationship between the transfer bandwidth 25AC and the available transfer time frame 25AD with respect to the main volume name 25AA of the main volume 11A is stored in the remote copy management table 25A in advance, and an administrator specifies only the main volume name 25AA of the main volume 11A, the snapshot program 23A, in place of the management program 35, may retrieve the transfer bandwidth 25AC and the available transfer time frame 25AD by referring to the remote copy management table 25A. Incidentally, processing in step S1 may be regularly executed by an OS (Operating System) by using, for example, a “cron,” etc.

A typical method for specifying the values of the transfer bandwidth 25AC and the available transfer time frame 25AD is a method where an administrator selects the main volume name 25AA of the main volume 11A in a table 36A, enters the transfer bandwidth 25AC in the area 36D, and enters the available transfer time frame 25AD in the area 36E by using the screen layout 36 displayed on the screen 34. Also, a method for specifying the values of the transfer bandwidth 25AC and the available transfer time frame 25AD may be automatically implemented based on a predetermined program.

Next, the snapshot program 23A in the main computer 3 selects the generation following the generation of the already created snapshot as the generation of a snapshot to be newly created, with reference to the COW table 21A (S2).

Then, the snapshot program 23A resets the transfer amount to “0,” and executes steps S4-S8 on all block numbers in the main volume 11A (S3).

The snapshot program 23A retrieves the difference block number 21AC located at the junction of the block numbers in step S3 and a creation-targeted snapshot generation, and the difference block number 21AC located at the junction of the block numbers in step S3 and the previous generation; and checks whether or not those difference block numbers are identical (S4). If those difference block numbers are identical (S4: Yes), the snapshot program 23A adds one block number in order to check the following block number and returns to step S3, without adding the block having the former difference block number to the transfer amount since the block is the same as that at the previous generation (S9). On the other hand, if those difference block numbers are not identical (S4: No), it means that the block needs to be transferred, so the snapshot program 23A adds the block to the transfer amount (S5).

Next, the snapshot program 23A determines an available transfer size by multiplying the transfer bandwidth and the available transfer time frame specified by the administrator in the above; and compares the transfer amount to the available transfer size (S6). If the transfer amount does not exceed the available transfer size (S6: No), the snapshot program 23A adds one block number in order to check the following block number, and returns to step S3 (S9). On the other hand, if the transfer amount exceeds the available transfer size (S6: Yes), the snapshot program 23A copies the difference block number 21AC located at the junction of the block number in step S3 and a creation-targeted snapshot generation to the difference block number 21AC located at the junction of the block number in step S3 and a generation following the creation-targeted snapshot generation (S7).

The snapshot program 23A changes the difference block number 21AC located at the junction of the block number in step S3 and a creation-targeted snapshot generation to the difference block number 21AC located at the junction of the block number in step S3 and a generation before the creation-targeted snapshot generation (S8). Here, the difference block number 21AC located at the junction of the block number in step S3 and a generation before the creation-targeted snapshot generation is an example of a value showing that the block has no change, so any other value may be applied as long as a similar object can be achieved.

Following the above, the snapshot program 23A adds one block number in order to check the following block number, and returns to step S3 (S9). If all of processing steps in steps S4-S8 are executed on all blocks in the main volume 11A (S3: Yes), the snapshot program 23A eventually reports the management program 203 that the processing is completed. Then the management program 35 reports the administrator that processing is complete, and terminates the processing in the flowchart according to the first embodiment. If the number of blocks copied in step S7 and S8 is too many, it is possible that the processing described in the first embodiment has to be executed again when creating the snapshot of a following generation, so the snapshot program 23A may alert the administrator when the number of blocks copied in step S7 and S8 exceeds a certain threshold value.

According to the first embodiment, the main computer 3 creates a snapshot so as to prevent the difference amount from the snapshot of the previous-generation from exceeding an available transfer size determined from a transfer bandwidth and available transfer time frame 25AD. Consequently, when transferring a snapshot created in the first embodiment, the transfer amount will not exceed the available transfer size, so it is possible to effectively prevent a business from being damaged by planned transfer periods being exceeded, or transfer failures.

### (2) Second Embodiment

According to the first embodiment, the transfer amount between a creation-targeted snapshot generation and the previous generation will never exceed an available transfer size. However, if there are plural generations between the transferred generation and a generation to be transferred, it is possible that the difference between those generation exceeds an available transfer size. Therefore, the second embodiment illustrates a method of transferring up to the snapshot of the latest generation which does not exceed an available transfer size determined from the transfer bandwidth and the available transfer time frame, when transferring plural snapshots.

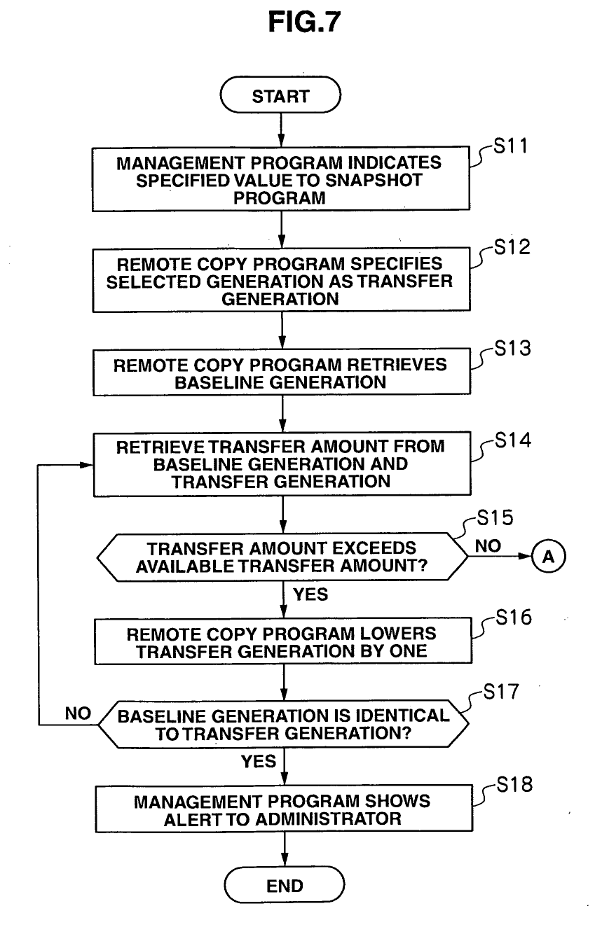

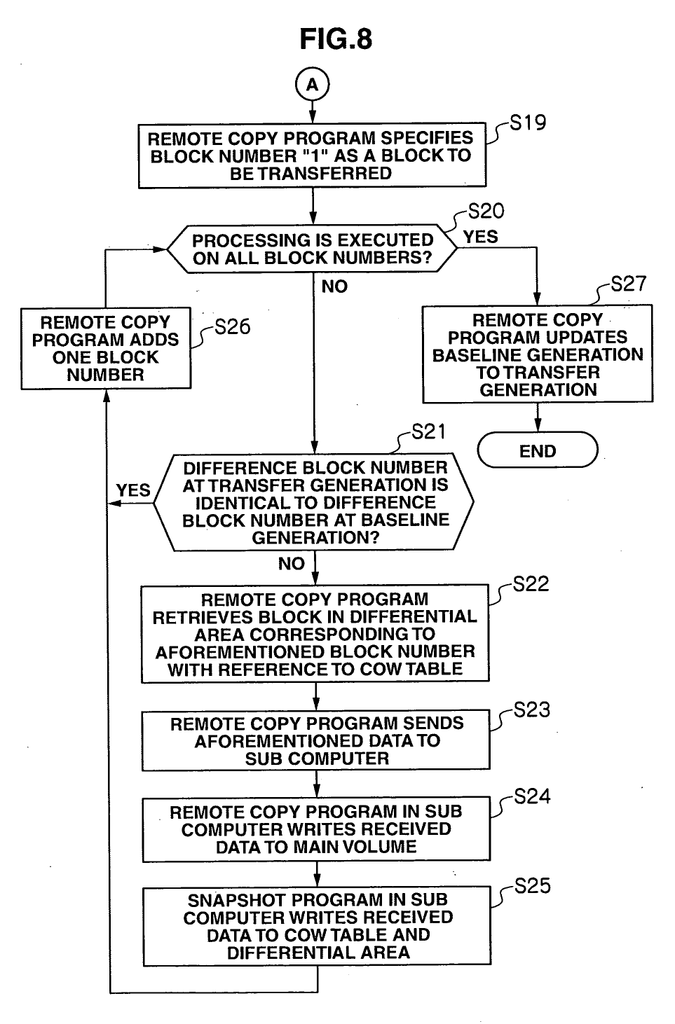

FIGS. 7 and 8 are flowcharts illustrating processing steps that will be described in the second embodiment. Accordingly, the second embodiment will be described below with reference to these flowcharts.

First, when an administrator specifies the main volume name 25AA of the main volume 11A to be transferred, and the generation, the sub-computer name 25AB, the transfer bandwidth 25AC and the available transfer time frame 25AD of a snapshot to be transferred; and the create button 361 is pressed, the management program 35 in the management computer 5 starts processing steps in the flowcharts according to the second embodiment, and directs the main computer 3 to transfer the snapshot by specifying the main volume name 25M, the sub-computer name 25AB, the transfer bandwidth 25AC and the available transfer time frame 25AD of the main volume 11A (S11).

In that case, if the relationship between the sub-computer name 25AB, the transfer bandwidth 25AC and the available transfer time frame 25AD with respect to the main volume name 25AA of the main volume 11A is stored in the remote copy management table 25A in advance, and an administrator specifies only the main volume name 25AA of the main volume 11A, the remote copy program 24A, in place of the management program 35, may retrieve the sub-computer name 25AB, the transfer bandwidth 25AC and the available transfer time frame 25AD with reference to the remote copy management table 25A.

Next, the remote copy program 24A in the main computer 3 selects the generation of the snapshot selected by the administrator as above as a generation to be transferred (hereinafter referred to as the “transfer generation”) (S12).

The remote copy program 24A retrieves the baseline generation 25AE of a snapshot with reference to the remote copy management table 25A (S13). Here, the baseline generation 25AE of a snapshot is initially set as the “generation 1.”

The remote copy program 24A determines a transfer amount by retrieving the difference between the baseline generation and the transfer generation with reference to the COW table 21A (S14). The transfer amount determination in step S14 can be implemented by repeating steps S3-S5 in the first embodiment.

Next, the remote copy program 24A determines the available transfer size by multiplying the transfer bandwidth 25AC and the available transfer time frame 25AD specified by the administrator in the above; and compares the transfer amount to the available transfer size (S15). If the transfer amount exceeds the available transfer size (S15: Yes), the snapshot program 23A sets a generation one generation older than the current transfer generation as a transfer generation (S16).

If the transfer generation is identical to the baseline generation (S17: Yes), it means that the amount to be transferred is too large to transfer with respect to an available transfer size, so the remote copy program 24A reports to the management program 35 accordingly. Then, the management program 35 alerts the administrator accordingly (S18), and terminates processing in the flowchart according to the second embodiment. On the other hand, if the transfer amount does not exceed the available transfer size (S15: No), the remote copy program 24A starts transfer processing.

FIG. 8 is a flowchart illustrating transfer processing steps in the second embodiment. First, the remote copy program 24A specifies the block number “1” as a block to be transferred (S19).

Next, the remote copy program 24A executes steps S21-S26 on all block numbers in the main volume 11A (S20).

The remote copy program 24A retrieves the difference block number 21AC located at the junction of the block numbers in step S3 and a transfer generation, and the difference block number 21AC located at the junction of the block numbers in step S3 and the baseline generation with reference to the COW table 21A; and checks whether or not those difference block numbers are identical (S21). If those difference block numbers are identical (S21: Yes), the remote copy program 24A decides that a block having that difference block does not have to be transferred, since it is identical to a block at the baseline generation; adds one block number in order to check the following block number; and returns to step S20 (S26). On the other hand, if those difference block numbers are identical (S21: No), the remote copy program 24A retrieves the difference block number 21AC of the transfer generation with reference to the COW table 21A, and retrieves data stored in the aforementioned block number 21AC in the differential area 22AC (S22).

Next, the remote copy program 24A sends the aforementioned data to the sub-computer 4 (S23).

The remote copy program 24B in the sub-computer 4 receives the aforementioned data, and directs the snapshot program 23B in the sub-computer 4 to write the data into the block having the aforementioned block number in the main volume 11B (S24).

The snapshot program 23B in the sub-computer 4 copies the block having the aforementioned block number to the differential area 22B, and enters the difference block number 21BC in the differential area 22B copied at the junction of the transfer generation in the COW table 21B in the sub-computer 4 and the aforementioned block number (S25).

With the above-described processing steps, the remote copy program 24A completes transfer processing in the sub-computer 4, adds one block number in order to check the following block number, and returns to step S20 (S26).

If all of the processing steps in steps S21-S26 are executed for all block numbers (S20: Yes), the remote copy program 24A updates the baseline generation 25AE of the main volume name 25M of the aforementioned main volume 11A in the remote copy management table 25A to a transfer generation (S27); and reports the management program 35 that the processing is completed. Then, the management program 35 reports the administrator that processing is completed; and terminates the processing in the flowchart.

According to the first embodiment, the main computer 3 transfers up to the snapshot of the latest generation not exceeding an available transfer size determined from the transfer bandwidth 25AC and the available transfer time frame 25AD, when transferring plural snapshots. Consequently, when transferring a snapshot created in the second embodiment, the transfer amount will not exceed an available transfer size, so it is possible to effectively prevent a business from being damaged by planned transfer periods being exceeded, or transfer failures.

### (3) Third Embodiment

According to the first embodiment, the transfer amount between a creation-targeted snapshot generation and the previous generation will never exceed an available transfer size. However, if the transfer bandwidth is smaller than that in the case when a snapshot is created in accordance with the first embodiment, there is a possibility that a transfer amount exceeds an available transfer size when transferring a snapshot. Therefore, the third embodiment illustrates a method of making a relevant snapshot unavailable when a transfer amount exceeds an an available transfer size.

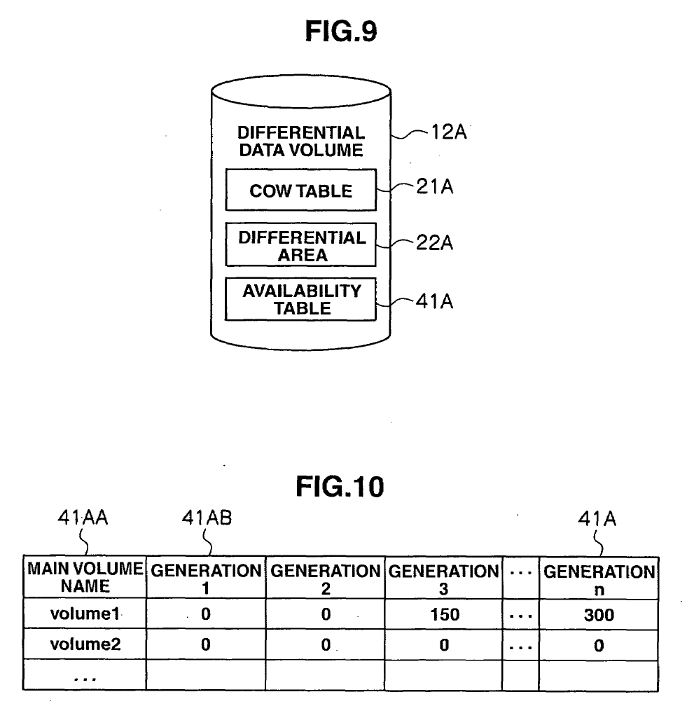

FIG. 9 shows the difference data volume 12A used in the third embodiment. In addition to the COW table 21A and the differential area 22A, the availability table 41A is arranged in the difference data volume 12A, and a flag indicating whether or not each snapshot is available is stored in the availability table 41A. Configurations other than the above are the same as those of the main computer 3 in the first embodiment.

Incidentally, with regard to the sub-computer 4, as in the case of the main computer 3, the availability table 41B is arranged in the difference data volume 12B. If the availability tables 41A, 41B are arranged in both the main computer 3 and the sub-computer 4, when, for example, a failure occurred in the main computer 3 and data is restored from the sub-computer 4, the content as well as data in the availability table 41B held by the sub-computer 4 is restored in the availability table 41A in the main computer 3, so that it is possible to effectively prevent the main computer 3 from mistakenly accessing an unavailable snapshot.

FIG. 10 is an example of the availability table 41. The availability table 41 includes, at least, a main volume name 41AA for which a snapshot creation is targeted, and a generation 41AB of a snapshot whose availability is determined. This example shows, in the availability table 41, “0” is stored when the generation 41AB of a relevant main volume name 41AA is available; and “the most recently transferred block number” is stored when the generation 41AB of a relevant main volume name 41AA is unavailable, and each stored value serves as a flag.

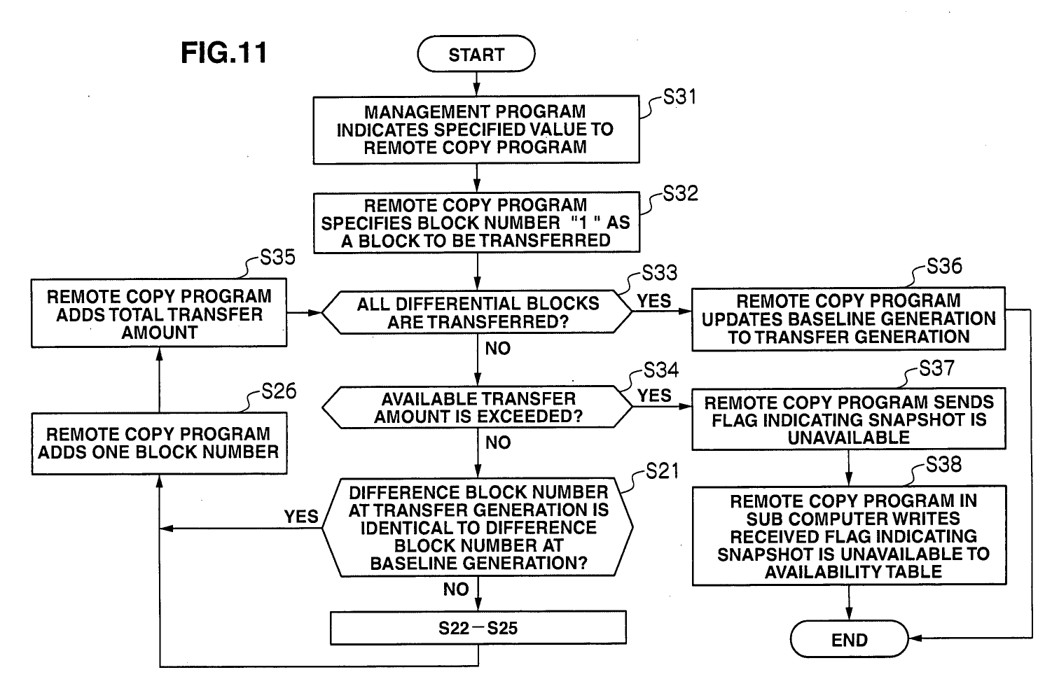

FIG. 11 is a flowchart illustrating processing steps that will be described in the third embodiment. Accordingly, the third embodiment will be described below with reference to this flowchart.

First, when an administrator specifies the main volume name 25AA of the main volume 11A to be transferred, and the generation (hereinafter referred to as the “transfer generation”), the transfer bandwidth 25AC and the available transfer time frame 25AD of a snapshot to be transferred; and the create button 361 is clicked, the management program 35 in the management computer 5 starts the processing steps in the flowchart according to the third embodiment, and directs the main computer 3 to transfer the snapshot by specifying the main volume name 25AA, the sub-computer name 25AB, the transfer bandwidth 25AC and the available transfer time frame 25AD of the main volume 11A (S31).

In that case, if the relationship of the sub-computer name 25AB, the transfer bandwidth 25AC and the available transfer time frame 25AD with respect to the main volume name 25AA of the main volume 11A is stored in the remote copy management table 25A in advance, and an administrator specifies only the main volume name 25AA of the main volume 11A, the remote copy program 24A, in place of the management program 35, and may retrieve the sub-computer name 25AB, the transfer bandwidth 25AC and the available transfer time frame 25AD with reference to the remote copy management table 25A.

Next, the remote copy program 24A in the main computer 3 specifies the block number “1” as a block to be transferred and resets the total transfer amount to “0” (S32). Then, the remote copy program 24A executes processings in steps S34, S35, and S21-S26 on all blocks in the main volume 11 (S33). If the remote copy program 24A did not execute those processing steps on all of the block numbers (S33: No), the remote copy program 24A checks whether or not the total amount exceeds the available transfer size (S34). If the total amount does not exceed the available transfer size (S34: No), the remote copy program 24A executes steps S21-S26. The details of steps S21-S26 are the same as those described in the second embodiment. Then, the remote copy program 24A adds the size of block transferred in step S23 to the total transfer amount (S35).

On the other hand, if the total amount exceeds the available transfer size (S34: Yes), the remote copy program 24A sends to the remote copy program 24B in the sub-computer 4 a flag indicating that the snapshot at the generation in the relevant main volume 11 is unavailable (S37). In the third embodiment, the remote copy program 24A sends a currently processing block number.

Next, the remote copy program 24B in the sub-computer 4 stores the received flag indicating that the snapshot is unavailable in the column for the relevant transfer generation (the generation 41AB) in the availability table 23 (S38), and repots the management program 35 that the processing is complete. Then the management program 35 reports the administrator that processing is complete, and terminates the processing in the flowchart.

If all processing steps in steps S34, S35, and S21-S26 were executed on all blocks in step S33 (S33: Yes), the remote copy program 24A eventually reports the management program 35 that the processing is completed. Then the management program 35 reports to the administrator that processing is complete, and terminates the processing in the flowchart.

According to the third embodiment, when a transfer amount exceeds an available transfer size, the main computer 3 makes the relevant snapshot unavailable. Consequently, in the third embodiment, when a snapshot exceeding the available transfer size is remote-copied, it is possible to effectively prevent an administrator from accidentally using a snapshot which has not been transferred. Also, since it is possible to restart processing from a block number following the previously transferred block number when transferring the aforementioned snapshot next time, the transfer time period can be reduced.

### (4) Fourth Embodiment

According to the first embodiment, the transfer amount between a creation-targeted snapshot generation and the previous generation will never exceed an available transfer size. However, if an administrator regularly sets the time for creating a snapshot and the time for transferring a snapshot in advance, there is a possibility that the amount of generated snapshots is too large to transfer in an originally assumed transfer cycle. The fourth embodiment illustrates a method of preventing a transfer amount from exceeding an available transfer size, when creating the next snapshot, by modifying the creation time for a next snapshot when a transfer amount exceeds an an available transfer size.

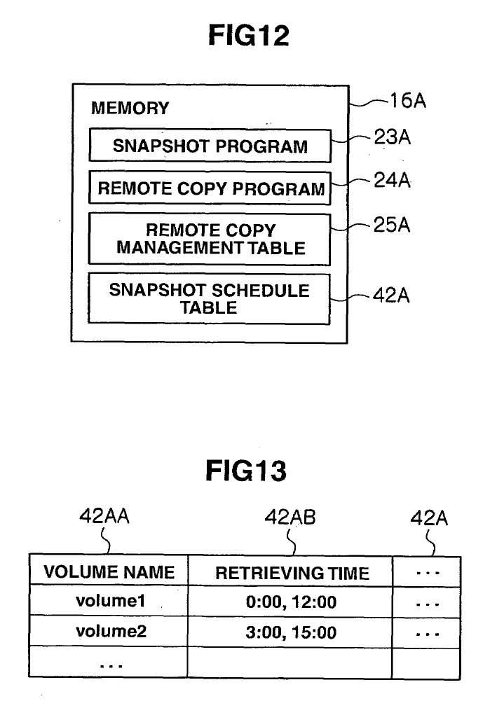

FIG. 12 shows memory 16A used in the fourth embodiment. In addition to the snapshot program 23A, the remote copy program 24A, and the snapshot table 25A, the snapshot schedule table 42A is stored in the memory 16A. Incidentally, with regard to the sub-computer 4, as in the case of the main computer 3, the snapshot schedule table 42B is arranged in memory 16B.

FIG. 13 is an example of the snapshot schedule table 42A. The snapshot schedule table 42A includes at least the main volume name 42AA and the time 42AB for retrieving a snapshot (hereinafter referred to as the “retrieving time 42AB”).

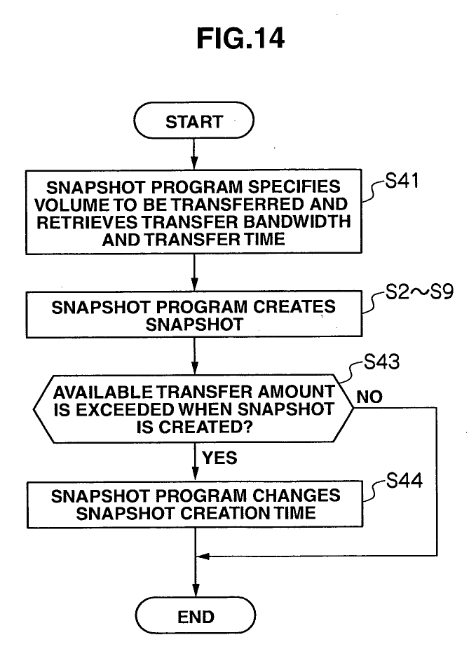

FIG. 14 is a flowchart illustrating processing steps that will be described in the fourth embodiment. Accordingly, the fourth embodiment will be described below with reference to this flowchart.

First, when the time for retrieval comes, an OS specifies and activates the main volume name 25AA for which a snapshot is created, then the snapshot program 23A in the main computer 3 starts the processing steps in the flowchart according to the fourth embodiment and retrieves the transfer bandwidth 25AC, the available transfer time frame 25AD, and the baseline generation 25AE for the main volume name 25AA of the main volume 11 with reference to the remote copy management table 25A (S41).

Incidentally, in place of an OS, a schedule management program, such as “cron,” etc., may activate the snapshot program 23A.

Next, the snapshot program 23A executes processing steps in steps S2-S9 described in the first embodiment. If a transfer amount does not exceed an available transfer size in steps S2-S9 (S43: No), the snapshot program 23A terminates the processing in the flowchart according to the first embodiment. On the other hand, if a transfer amount does not exceed the available transfer size (S43: Yes), the snapshot program 23A determines the amount of time required to transfer a snapshot by dividing the transfer amount by the transfer bandwidth; resets the time for a next snapshot creation to begin after the aforementioned amount of time required is passed (S44), and then terminates the processing in the flowchart according to the first embodiment.

According to the fourth embodiment, when a transfer amount exceeds an available transfer size, the main computer 3 can create a next snapshot so as to prevent a transfer amount from exceeding an available transfer size by changing a creation time for the next snapshot. Consequently, it is possible to effectively prevent a business from being damaged by planned transfer periods being exceeded, or transfer failures.

The present invention can be broadly applied to a computer system having a function to copy data between more than one computer.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. A storage device having a volume for storing data sent from a host computer and transferring the data stored in the volume to a sub storage device via a network, comprising:
a retrieval unit for retrieving a snapshot retaining change data generated in the volume during a time period between a given time and another given time, and a maximum transfer size transferred between the sub storage device and the network; and
a control unit for controlling the storage device so as to store data exceeding a maximum transfer size in the area of another snapshot, when the size of a created snapshot exceeds the maximum transfer size.

2. The storage device according to claim 1, wherein:
the retrieval unit retrieves a creation time for the snapshot; and wherein
when the size of a created snapshot exceeds the maximum transfer size, the control unit changes a creation time for a next snapshot so as to prevent the size of the snapshot from exceeding the maximum transfer size when creating the next snapshot.

3. The storage device according to claim 1, wherein:
the retrieval unit retrieves information indicating whether or not the snapshot is available; and wherein
when a certain snapshot is transferred to the sub storage device and if the size of the certain snapshot exceeds the maximum transfer size, the control unit transfers, from among the snapshots, data up to the maximum transfer size, and reports to the retrieval unit and the sub storage device that the relevant snapshot is unavailable.

4. A storage device having a volume for storing data sent from a host computer and transferring the data stored in the volume to a sub storage device via a network, comprising:
a retrieval unit for retrieving a plurality of snapshots retaining change data generated in the volume during a time period between a given time and another given time, a snapshot which was transferred to the sub storage device, and a maximum transfer size of the network with the sub storage device; and
a control unit for controlling the storage device so as to select a latest snapshot from among the plurality of snapshots as the snapshot to be transferred so as to prevent any difference between the snapshot to be transferred and a transferred snapshot from exceeding the maximum transfer size, when the plurality of snapshots are transferred to the sub storage device.

5. A method of controlling a storage device including a volume for storing data sent from a host computer and transferring the data stored in the volume to a sub storage device via a network, comprising:
a first step wherein a retrieval unit retrieves a snapshot retaining change data generated in the volume during a time period between a given time and another given time, and a maximum transfer size between the sub storage device and the network; and
a second step wherein a control unit controls the storage device so as to store data exceeding a maximum transfer size in the area of another snapshot, when the size of a created snapshot exceeds the maximum transfer size.

6. The method of controlling a storage device according to claim 5, wherein:
in the first step, the creation time for the snapshot is retrieved; and wherein
in the second step, when the size of the created snapshot exceeds the maximum transfer size, the creation time for next snapshot is changed so as to prevent the size of the snapshot from exceeding the maximum transfer size when creating the next snapshot.

7. The method of controlling a storage device according to claim 5, wherein:
in the first step, information indicating whether or not the snapshot is available is retrieved; and wherein
in the second step, when a certain snapshot is transferred to the sub storage device and if the size of the certain snapshot exceeds the maximum transfer size, data, from among the snapshots, up to the maximum transfer size is transferred, and the control unit reports to the retrieval unit and the sub storage device that the relevant snapshot is unavailable.

8. The method of controlling a storage device according to claim 5, wherein:
in the first step, a snapshot which was transferred to the sub storage device is retrieved; and wherein
in the second step, a latest snapshot from among the plurality of snapshots is selected as the snapshot to be transferred so as to prevent any difference between the snapshot to be transferred and a transferred snapshot from exceeding the maximum transfer size, when the plurality of snapshots are transferred to the sub storage device.
